(19) United States
(12) Patent Application Publication
(10) Pub. No.: US 2011/0153149 A1
(43) Pub. Date: Jun. 23, 2011

(54) COMMUNICATION APPARATUS AND METHOD FOR VEHICLE USING IPv6 NETWORK

(75) Inventors: Hong Seok Jeon, Daejeon (KR); Chang Min Park, Daejeon (KR); So Yeon Lee, Daejeon (KR); Hyun Jeong Yun, Daejeon (KR)

(73) Assignee: Electronics and Telecommunications Research Institute, Daejeon (KR)

(21) Appl. No.: 12/885,835

(22) Filed: Sep. 20, 2010

(30) Foreign Application Priority Data
Dec. 17, 2009 (KR) 10-2009-0125881

(51) Int. Cl. G06F 19/00

(52) U.S. Cl. 701/32; 701/1; 701/33

(57) ABSTRACT

A communication apparatus for a vehicle using an Internet protocol version 6 (IPv6) network is disclosed. The communication apparatus may include at least one Electronic Control Unit (ECU) having an IPv6 network communication function, and a vehicle gateway to support vehicle internal communication network to communicate with the at least one ECU and to support vehicle external communication network for a communication with a terminal of a service provider.

### CROSS-REFERENCE TO RELATED APPLICATION

This application claims the priority benefit of Korean Patent Application No. 10-2009-0125881, filed on Dec. 17, 2009, in the Korean Intellectual Property Office, the disclosure of which is incorporated herein by reference.

### BACKGROUND

1. Field

One or more embodiments relate to a communication apparatus and method for a vehicle, and more particularly, to a communication apparatus and method for a vehicle using an Internet Protocol version 6 (IPv6) network.

2. Description of the Related Art

To support an Internet Protocol version 4 (IPv4) communication scheme in a controller area network (CAN), that is, a vehicle internal communication network, a method of transforming a CAN message may be used. The CAN is a network for a communication between Electronic Controller Units (ECUs) of a vehicle, and it is based on a bus topology such as a CAN-Bus. In the CAN, a message transmission between the ECUs is performed based on an identifier of a message transmitted through the CAN-Bus.

However, for an Internet Protocol (IP) communication scheme, an identifier for a CAN node needs to be defined. Also, a segmentation operation where an IP packet having a payload of a maximum of 1500 bytes is segmented into CAN messages having a maximum of 8 bytes needs to be performed.

In this regard, a technology of transforming an IPv4 message into the CAN message by defining an Internet Gateway Service (IGS) function has been used. For an identifier of the CAN node, the IGS uses lower 8 bits of an IP address allocated to the CAN node, and records the lower 8 bits in a message identifier of the CAN message header of 29 bits, so that the IP packets are segmented into the CAN messages of 8 bytes.

However, the above technology using IGS allows only IPv4 packets to be transmitted in the CAN network. Hence a problem such as an address depletion may arise and thus all ECUs cannot be allocated with global unique IP addresses.

### SUMMARY

One or more embodiments provide a communication apparatus and method for a vehicle, which may generate globally unique IP addresses to be allocated to all Electronic Control Units (ECUs).

One or more embodiments also provide a communication apparatus and method for a vehicle, in which an external network node may be connected to an ECU via an Internet Protocol version 6 (IPv6) network to perform a communication.

According to an aspect of one or more embodiments, there may be provided a communication apparatus for a vehicle using an Internet protocol version 6 (IPv6) network, the communication apparatus including: at least one Electronic Control Unit (ECU) having an IPv6 network communication function; and a vehicle gateway to support vehicle internal communication network for communications with the at least one ECU and to support vehicle external communication network for communications with a terminal of a service provider.

According to another aspect of one or more embodiments, there may be provided a communication apparatus for a vehicle using an IPv6 network, the communication apparatus including: a terminal of a service provider to establish a connection to at least one ECU of the vehicle using the IPv6 network, and provide vehicle diagnostics/management services based on the established connection; and a vehicle gateway to be connected to the at least one ECU and to support vehicle internal/external communication network.

According to still another aspect of one or more embodiments, there may be provided a communication method of a communication apparatus for a vehicle using an IPv6 network, the communication method including: extracting identifier information from at least one ECU having an IPv6 network communication function; and generating an IPv6 address of the at least one ECU with the extracted identifier information and mobile network prefix allocated to a vehicle gateway.

According to yet another aspect of one or more embodiments, there may be provided a communication method of a communication apparatus for a vehicle using an IPv6 network, the communication method including: extracting interface identifier information from predetermined bits of a destination IPv6 address of a packet transmitted to an ECU; and extracting, from the interface identifier information, information used for identifying the ECU.

Additional aspects of embodiments will be set forth in part in the description which follows and, in part, will be apparent from the description, or may be learned by practice of is the disclosure.

### EFFECT

According to an embodiment, a vehicle-related service provider may establish an Internet Protocol version 6 (IPv6) connection with an Electronic Control Unit (ECU) of a remote vehicle via an IPv6 network, and may provide a variety of vehicle diagnostics/management services to the remote vehicle using the established IPv6 connection.

### BRIEF DESCRIPTION OF THE DRAWINGS

These and/or other aspects will become apparent and more readily appreciated from the following description of embodiments, taken in conjunction with the accompanying drawings of which:

FIG. 1 is a diagram used for describing a communication scheme of a communication apparatus for a vehicle using an Internet Protocol version 6 (IPv6) network according to an embodiment;

FIG. 2 is a diagram illustrating an example of a communication apparatus for a vehicle using an IPv6 network according to an embodiment;

FIG. 3 is a diagram illustrating a method of generating an IPv6 address of an Electronic Control Unit (ECU) according to an embodiment;

FIG. 4 is a diagram illustrating an IPv6 address of a generated ECU according to an embodiment;

FIG. 5 is a diagram illustrating a method of extracting identifier information of an ECU by a vehicle gateway according to an embodiment;

FIG. 6 is a diagram illustrating a vehicle information table according to an embodiment;

FIG. 7 is a diagram illustrating an ECU information table according to an embodiment; and

FIG. 8 is a diagram used for describing relation between a vehicle information table and an ECU information table according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

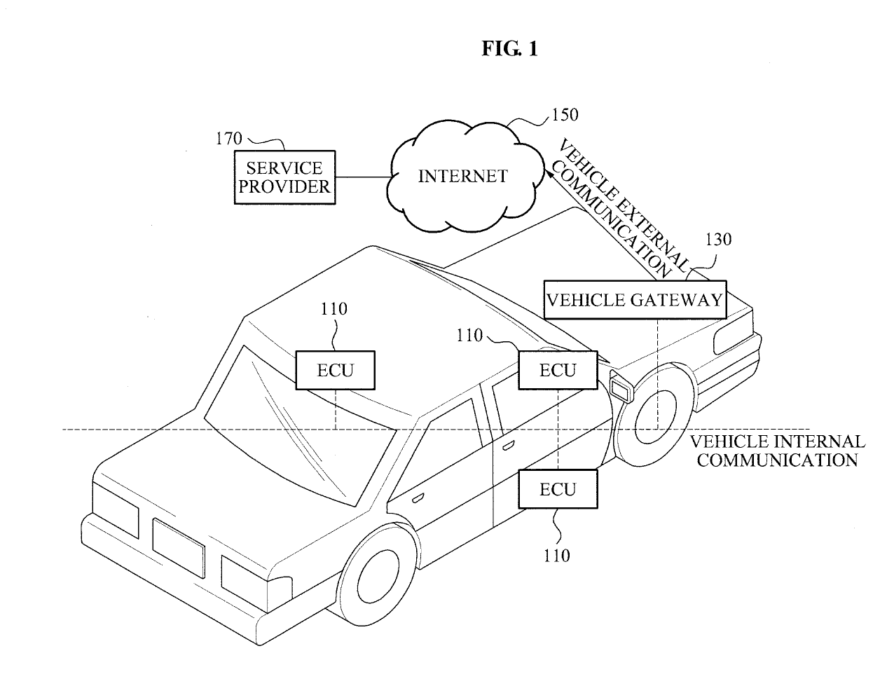

FIG. 1 shows an embodiment of the network system where a vehicle-related service provider communicates with Electronic Control Units in a remote vehicle using an Internet Protocol version 6 (IPv6) network in accordance with the embodiment of the invention.

Referring to FIG. 1, the communication apparatus according to an embodiment may include an Electronic Control Unit 110 (hereinafter, referred to as ‘ECU’), and a vehicle gateway 130.

The ECU 110 may be connected to the vehicle gateway 130 using a vehicle internal communication network, and may be connected to a terminal 170 of a service provider using an IPv6 communication.

The ECU 110 and the vehicle gateway 130 may be included in a vehicle, and at least one ECU 110 may be included in the vehicle to control various electronic equipments in the vehicle.

The vehicle gateway 130 may support the vehicle internal communication network to connect with the ECU 110, and support a vehicle external communication network via a network 150 such as the Internet and the like, to connect with the terminal 170 of the service provider.

Accordingly, a packet which the terminal 170 of the service provider sends out toward the ECU 110 over the network 150 may be transmitted to the vehicle gateway 130 using the vehicle external communication network, and the vehicle gateway 130 may transmit the packet to a corresponding ECU 110 using the vehicle internal communication network.

The vehicle gateway 130 may support a Network Mobility (NEMO, IETF RFC 3963) protocol for the purpose of network mobility.

Also, the vehicle gateway 130 may function as a mobile router of the NEMO protocol and thus, specific Mobile Network Prefix (MNP) is assigned to the vehicle gateway 130.

The vehicle gateway 130 may remove or compress some parameters included in each of an IPv6 header, a User Datagram Protocol (UDP) header, and a Transmission Control Protocol (TCP) header of a packet, each of the headers being transmitted to the ECU 110 using the vehicle external communication network so that the overall size of the packet can be reduced.

The terminal 170 of the service provider may provide various vehicle-related services, and may provide diagnostic management services of ECUs of a specific vehicle, in response to a request of a user.

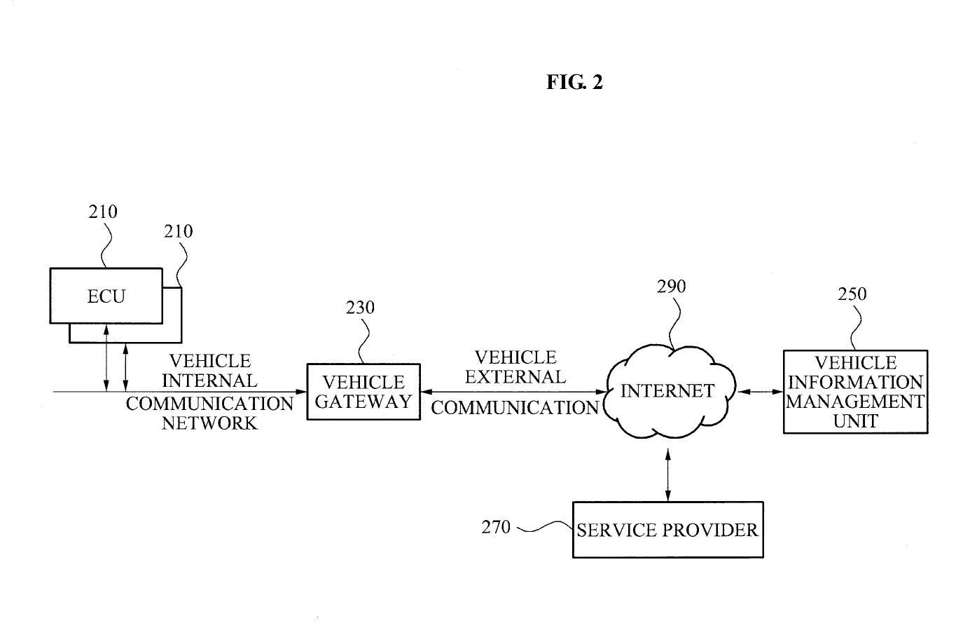

FIG. 2 is a diagram illustrating an example of a communication apparatus for a vehicle using an IPv6 network according to an embodiment.

Referring to FIG. 2, the communication apparatus for the vehicle using the IPv6 network includes an ECU 210 and a vehicle gateway 230. Also, the communication apparatus may further include a vehicle information management unit 250 and a terminal 270 of a service provider.

The ECU 210 may have an IPv6 network communication function, and the vehicle may have at least one ECU 210 to control internal electronic equipments of the vehicle.

The ECU 210 may include a power seat ECU controlling a motor used for seat movement of the vehicle, a tilt ECU having an inside mirror control function, a tilt control function and a telescoping control function of a steering wheel, an Anti-lock Braking System (ABS) ECU, an airbag ECU, a rear sensing ECU, and the like.

The at least one ECU 210 may be connected to the vehicle gateway 230 using the vehicle internal communication network, and connected to the terminal 270 of the service provider using the IPv6 network.

Also, the at least one ECU 210 may generate its own IPv6 address with Identifier (ID) information of each of the ECU 210 and MNP assigned to the vehicle gateway 230.

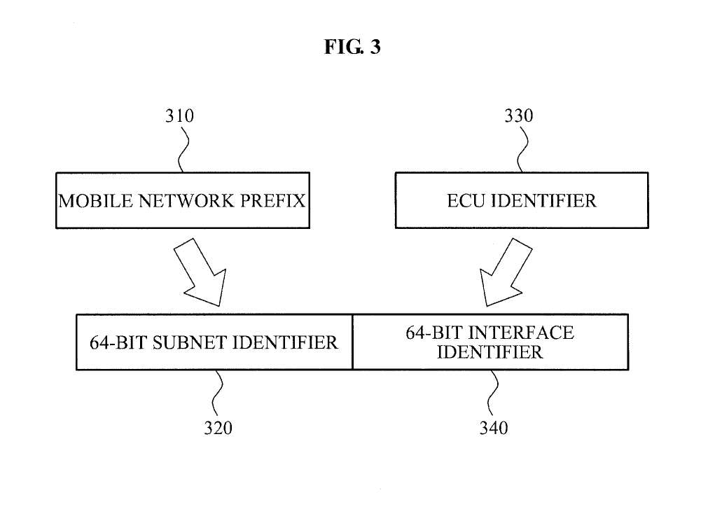

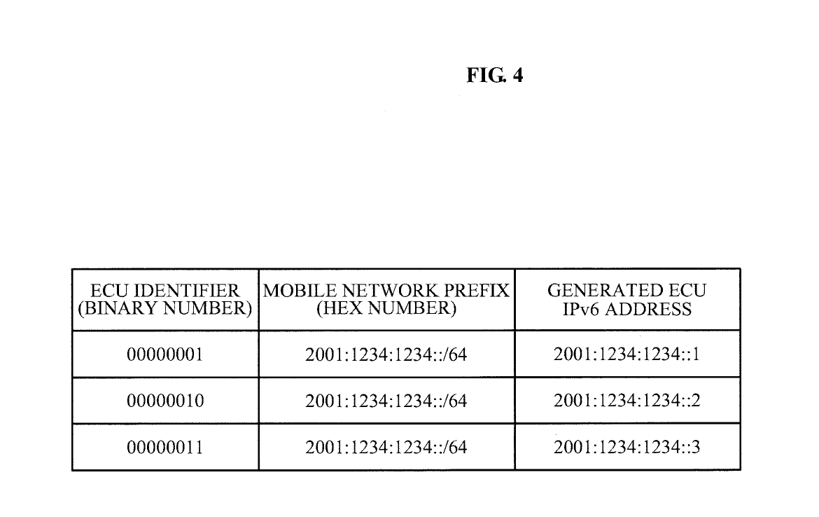

A method where the at least one ECU 210 generates its own IPv6 address and the IPv6 address generated by the method will be further described with reference to FIGS. 3 and 4.

FIG. 3 is a diagram illustrating a method of generating an IPv6 address of the ECU 210 according to an embodiment.

Referring to FIG. 3, the ECU 210 may generate the IPv6 address using ID information 330 of the ECU 210 and MNP 310 assigned to the vehicle gateway 230.

The ID information 330 may be information such as an address assigned to each ECU 210 so that ECU 210 may communicate with each other using the vehicle internal communication network.

The MNP 310 may be information about a prefix that a home network assigns to a mobile router to support network mobility using the NEMO protocol.

The IPv6 address may consist of a subnet identifier 320 of 64 bits and an interface identifier 340 of 64 bits.

The ECU 210 may generate the subnet identifier 320 of 64 bits with the MNP 310 assigned to the vehicle gateway 230 in order to configure its own IPv6 address.

The ECU 210 may generate the interface identifier 340 of 64 bits with the ECU ID 330 in order to configure its own IPv6 address.

Using the generated IPv6 address of the ECU 210, a terminal of a service provider spaced apart from the vehicle by a relatively long distance may establish an IPv6 connection with an ECU of a specific vehicle.

Also, with the established IPv6 connection, the ECU 210 may be provided with a variety of vehicle diagnostics/management services via an IPv6 network.

Specifically, for example, when being charged at a home and the like, an electric vehicle may be provided with a variety of vehicle diagnostics/management services through a wired/wireless Internet access, or may provide information about a corresponding vehicle to a service providing server.

FIG. 4 is a diagram illustrating generated ECU IPv6 addresses according to an embodiment.

Referring to FIG. 4, information of 8 bits may be used as ID information of the ECU.

Referring to FIG. 4, a mobile network prefix of 2001:1234:1234::/64 was assigned, in advance, to the vehicle gateway 230 where each of the at least one ECU 210 is connected.

To expand the 8-bit ID of the ECU 210 to the interface identifier of 64 bits, the remaining 56 bits may be filled with ‘0’. Also, when the MNP assigned to the vehicle gateway 230 is less than 64 bits, the remaining bits may be filled with ‘0’.

Accordingly, the ECU 210 having ID of ‘00000001’ may have 64 bit-interface ID information of ‘00000000 00000000 00000000 00000000 00000000 00000000 00000000 00000001’.

Consequently, the ECU 210 may combine the MNP of 2001:1234:1234::/64 and the to 64 bit-interface ID information of the ECU to generate its own IPv6 address of 2001:1234:1234::1.

Depending on embodiments, as described above, the terminal of the service provider may generate the IPv6 address of the ECU using the ID information of the ECU and the MNP assigned to the vehicle gateway, which will be described later.

The vehicle gateway 230 may support a vehicle internal communication network to communicate with the at least one ECU 210, and a vehicle external communication network to communicate with the terminal 270 of the service provider.

Also, the vehicle gateway 230 may remove or compress some parameters included in an IPv6 header, a User Datagram Protocol (UDP) header and a Transmission Control Protocol (TCP) header of a packet transmitted to the ECU 110 using the vehicle external communication network so that the overall size of the packet can be reduced.

The vehicle gateway 230 may use a method suggested in the IETF (Internet Engineering Task Force) 6LoWPAN (IPv6 over Low power WPAN) working group to remove or compress some of parameters included in the respective headers. In this regard, the suggested method may refer to ‘Header Compression’ in chapter 10 of an RFC4944.

The vehicle gateway 230 may function as a mobile router for supporting mobility of a vehicle.

Also, the vehicle gateway 230 may extract the ID information of the ECU 210 from a destination IPv6 address of the packet transmitted to the ECU 210, and transmit the packet to a corresponding ECU 210 using the extracted ID information.

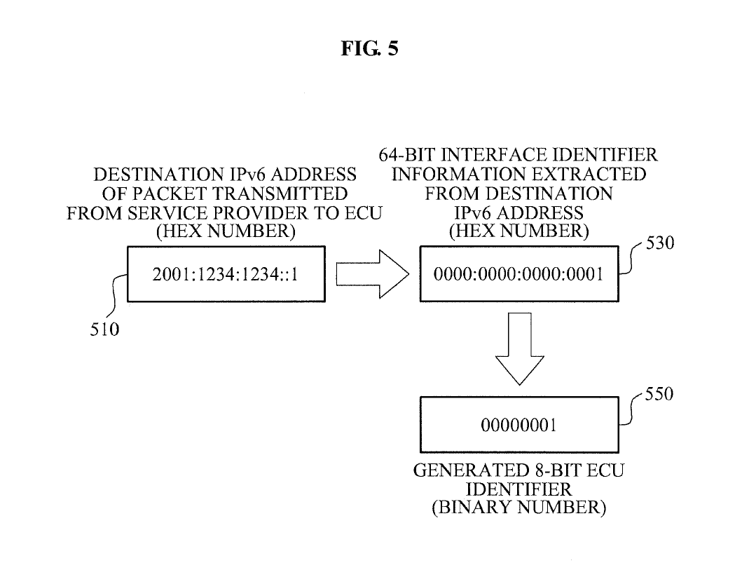

A method where the vehicle gateway 230 extracts the ID information of the ECU 210 from the destination IPv6 address of the packet transmitted to the ECU 210 using a vehicle external communication network will be further described with reference to FIG. 5.

FIG. 5 is a diagram illustrating a method of extracting ID information of an ECU by a vehicle gateway according to an embodiment.

Referring to FIG. 5, the vehicle gateway may extract the ID information of a corresponding ECU from a destination IPv6 address 510 of a packet transmitted to the ECU using a vehicle external communication network.

The vehicle gateway may extract 64-bit interface ID information 530 from the destination IPv6 address 510 of the packet transmitted to an ECU, and further extract, from the extracted 64-bit interface ID information 530, only ID information 550 corresponding to bits used for identifying the ECU.

When 8-bit information is used to identify an ECU of a vehicle and the destination IPv6 address 510 of a packet transmitted from a service provider is 2001:1234:1234::1, the 64-bit interface ID information 530 extracted from the destination IPv6 address may be expressed as ‘00000000 00000000 00000000 00000000 00000000 00000000 00000000 00000001’ in a binary notation (0000:0000:0000:0001 in hexadecimal notation), and ‘00000001’ of the lower 8 bits may be the ID of the ECU.

When receiving a packet transmitted to the ECU through the vehicle external communication network, the vehicle gateway may extract ID information of the ECU from the destination IPv6 address of the packet, and use the extracted ID information to transmit the packet to a corresponding ECU through a vehicle internal communication network.

The communication apparatus for the vehicle using the IPv6 network according to an embodiment may further include a vehicle information management unit 250.

The vehicle information management unit 250 may provide information required when a service provider provides services to a specific vehicle.

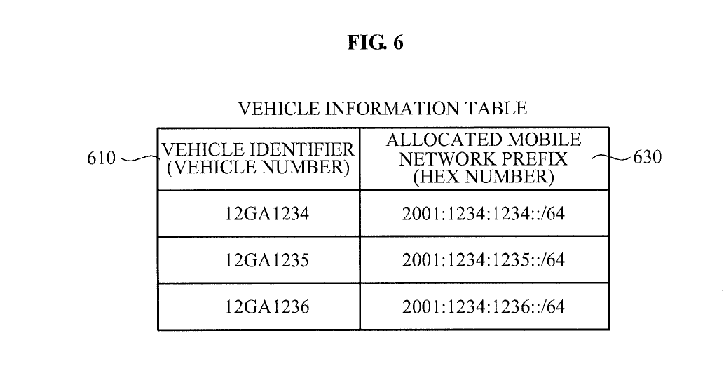

To provide services to a specific vehicle, the vehicle information management unit 250 may configure a vehicle information table including vehicle identifier for identifying a vehicle, and MNP assigned to a vehicle gateway equipped in a vehicle corresponding to the vehicle identifier. The vehicle information table will be further described with reference to FIG. 6.

FIG. 6 is a diagram illustrating a vehicle information table according to an embodiment.

Referring to FIG. 6, the vehicle information table may include vehicle identifier 610 and MNP 630 assigned to a vehicle gateway equipped in a vehicle corresponding to the vehicle identifier 610. Here, each row of the vehicle information table represents information about a specific vehicle.

Depending on embodiments, a vehicle's license plate may be used as the vehicle identifier 610.

Through the vehicle information table of FIG. 6, it may be understood that an MNP of 2001:1234:1235::/64 was assigned to a vehicle gateway of a vehicle having a license plate of 12 GA 1235.

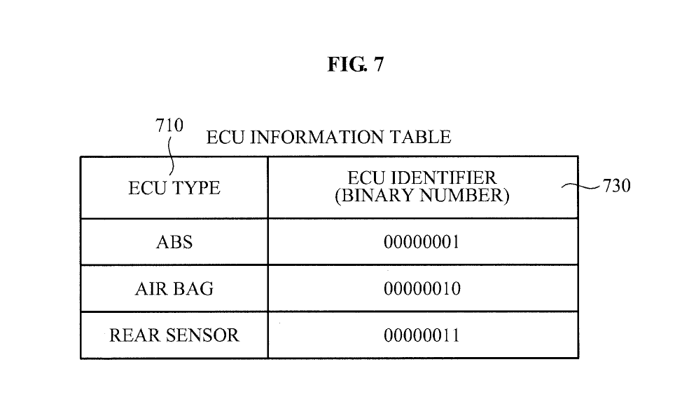

Also, the vehicle information management unit 250 may configure an ECU information table including information on type and ID of each of at least one ECU The ECU information table will be further described with reference to FIG. 7.

FIG. 7 is a diagram illustrating an ECU information table according to an embodiment.

Referring to FIG. 7, the ECU information table may include a type 710 of an ECU equipped in a specific vehicle and ID information 730 of the ECU.

The type 710 of the ECU may be represented with an object that the ECU tries to control, and it may enable a user to be easily aware of the purpose of the ECU.

As examples of the type 710 of the ECU, an Anti-lock Braking System (ABS) ECU, an airbag ECU, a rear sensing ECU, and the like may be given.

Referring to the ECU information table of FIG. 7, the ID information 730 of the ABS ECU may be ‘00000001’ in a binary notation.

Also, the ID information 730 of the airbag ECU may be ‘00000010’ in binary notation, and the ID information 730 of the rear sensing ECU may be ‘00000011’ in binary notation.

A service provider or a specific node where the service provider readily connects through a network may manage and own the vehicle information table and the ECU information table.

The vehicle information management unit 250 may transmit information in the vehicle information table or the ECU information table to a terminal of the service provider.

Also, the vehicle information management unit 250 may be managed by the terminal of the service provider or by a specific server that provides vehicle-related services.

If the vehicle information management unit 250 is managed by a specific server outside a vehicle, the terminal of the service provider may be connected to the vehicle information management unit 250 through the Internet and the like to enable the terminal of the service provider to be provided with the vehicle related information.

Also, depending on embodiments, the vehicle information management unit 250 may be managed in a vehicle, so that the vehicle related information may be provided to an outside vehicle service provider using a wireless communication scheme and the like.

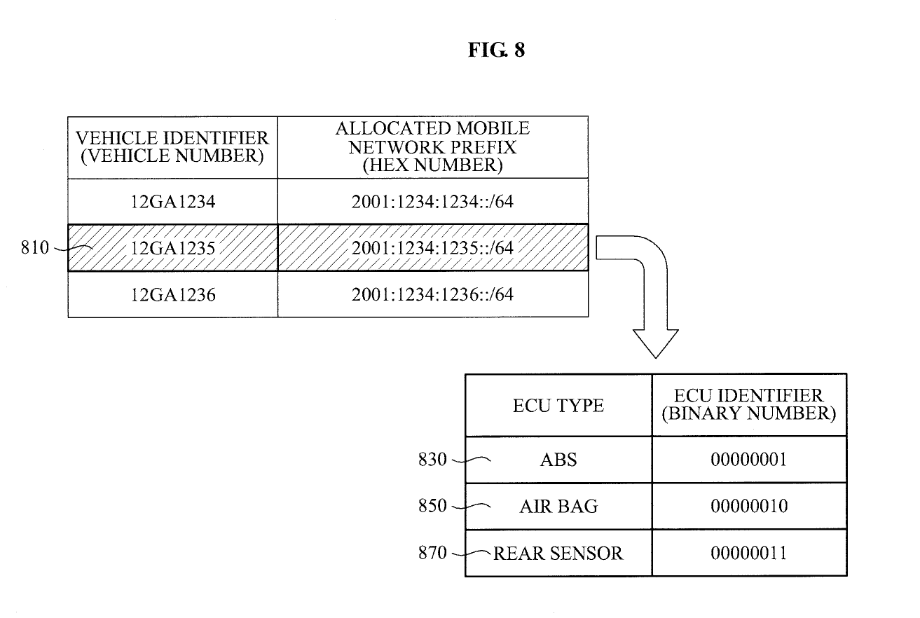

FIG. 8 is a diagram used for describing relation between a vehicle information table and an ECU information table according to an embodiment.

Referring to FIG. 8, the vehicle information table may provide vehicle identifiers and assigned MNPs for the specific vehicle for each row, and each row of the vehicle information table may have the ECU information table providing information about ECUs equipped in a corresponding vehicle.

For example, a vehicle 810 having a vehicle's license plate of 12GA1235 may have MNP of 2001:1234:1235::/64 given by hexadecimal digits, and it may be understood that an ABS ECU, an airbag ECU, and a rear sensing ECU may be equipped in the vehicle 810. Also, when an ID for each of the ECUs is expressed in a binary notation, the ABS ECU 830 may be ‘00000001’, the airbag ECU 850 may be ‘00000010’, and the rear sensing ECU 870 to may be ‘00000011’.

The methods and the operations of the communication apparatus which are described in FIGS. 1 to 8 may be identically applied between the communication apparatuses for the vehicle using the IPv6 network which is configured of the terminal of the service provider and the vehicle gateway.

According to another embodiment, the communication apparatus for the vehicle using the IPv6 network may include the terminal of the service provider that establishes an IPv6 connection to at least one ECU through IPv6 network and provides vehicle diagnostics/management services using the established IPv6 connection, and the vehicle gateway connected to the at least one ECU to support vehicle internal/external communication network.

For this, the terminal of the service provider may generate an IPv6 address of at least one ECU using the ID information of the at least one ECU and the MNP assigned to the vehicle gateway.

A method of generating the IPv6 address of the ECU by the terminal of the service provider may use a method of generating the IPv6 address by the ECU as described in FIGS. 3 and 4.

Further descriptions of the vehicle gateway and the vehicle information management unit will refer to the corresponding descriptions of FIGS. 1 to 8.

Also, the service provider may be subjected to a process, which will be described below, to communicate with a specific ECU of a specific vehicle using an IPv6 communication scheme.

The service provider may obtain MNP of a specific vehicle from a vehicle information table, may obtain ID information of a specific type of an ECU from an ECU information table of a corresponding vehicle, and may generate an IPv6 address of the ECU through the communication method of the communication apparatus for the vehicle using the to IPv6 network described in FIGS. 3 to 8.

The methods according to the above-described embodiments may be recorded in computer-readable non-transitory storage media including program instructions to implement various operations embodied by a computer. The media may also include, alone or in combination with the program instructions, data files, data structures, and the like. Examples of computer-readable non-transitory media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. A communication apparatus for a vehicle using an Internet Protocol version 6 (IPv6) network, the communication apparatus comprising:
at least one Electronic Control Unit (ECU) having an IPv6 network communication function; and
a vehicle gateway to support vehicle internal communication network to communicate with the at least one ECU and to support vehicle external communication network to communicate with a terminal of a service provider.

2. The communication apparatus of claim 1, wherein the at least one ECU generates its own IPv6 address using its identifier information and mobile network prefix assigned to the vehicle gateway.

3. The communication apparatus of claim 1, wherein the vehicle gateway removes or compresses some of parameters included in each of an IPv6 header, a User Datagram Protocol (UDP) header, and a Transmission Control Protocol (TCP) header of a packet, each of the headers being transmitted to the ECU using the vehicle external communication network so that the overall size of the packet is reduced.

4. The communication apparatus of claim 1, wherein the vehicle gateway functions as a mobile router for supporting mobility of the vehicle.

5. The communication apparatus of claim 1, wherein the vehicle gateway extracts identifier information of the ECU from a destination IPv6 address of a packet being transmitted to the at least one ECU, and transmits the packet to a corresponding ECU based on the extracted identifier information.

6. The communication apparatus of claim 1, further comprising:
a vehicle information management unit to configure a vehicle information table including vehicle identifier for identifying the vehicle and mobile network prefix assigned to the vehicle gateway equipped in the vehicle corresponding to the vehicle identifier information.

7. The communication apparatus of claim 1, wherein the vehicle information management unit configures an ECU information table including a type and identifier information of the at least one ECU.

8. The communication apparatus of claim 7, wherein the vehicle information management unit provides, to the terminal of the service provider, information of the ECU information table.

9. The communication apparatus of claim 8, wherein the vehicle information management unit is managed by at least one of the terminal of the service provider and a server.

10. The communication apparatus of claim 8, wherein the vehicle information table includes the information of the ECU information table.

11. A communication apparatus for a vehicle using an IPv6 network, comprising:
a terminal of a service provider to establish a connection between at least one ECU of the vehicle and the terminal of the service provider using the IPv6 network, and provide vehicle diagnostics/management services based on the established connection; and
a vehicle gateway to be connected to the at least one ECU and to support vehicle internal/external communication network.

12. The communication apparatus of claim 11, wherein the terminal of the service provider generates an IPv6 address of the at least one ECU using identifier information of the at least one ECU and mobile network prefix allocated to the vehicle gateway.

13. The communication apparatus of claim 11, wherein the vehicle gateway removes or compresses some of parameters included in each of an IPv6 header of a packet, a user datagram protocol (UDP) header of the packet, and a transmission control protocol (TCP) header of the packet, each of the headers being transmitted to the ECU using the vehicle external communication network so that the overall size of the packet is reduced.

14. The communication apparatus of claim 11, wherein the vehicle gateway functions as a mobile router for supporting mobility of the vehicle.

15. The communication apparatus of claim 11, wherein the vehicle gateway extracts, from a destination IPv6 address of a packet transmitted to the at least one ECU, identifier information of the at least one ECU, and transmits the packet to the at least one ECU based on the extracted identifier information.

16. The communication apparatus of claim 11, further comprising:
a vehicle information management unit to configure a vehicle information table including vehicle identifier information for identifying the vehicle and mobile network prefix allocated to the vehicle gateway mounted in the vehicle corresponding to the vehicle identifier information.

17. The communication apparatus of claim 11, wherein the vehicle information management unit configures an ECU information table including a type and identifier information of the at least one ECU.

18. The communication apparatus of claim 16, wherein the vehicle information management unit provides, to the terminal of the service provider, the vehicle information table or information of the ECU information table.

19. A communication method of a communication apparatus for a vehicle using an IPv6 network, the communication method comprising:
extracting identifier information from at least one ECU having an IPv6 network communication function; and
generating an IPv6 address of the at least one ECU using the identifier information and mobile network prefix allocated to a vehicle gateway.

20. A communication method of a communication apparatus for a vehicle using an IPv6 network, the communication method comprising:
extracting interface identifier information from predetermined bits of a destination IPv6 address of a packet transmitted to an ECU; and
extracting information used for identifying the ECU from the interface identifier information.
